(19) United States
(12) Patent Application Publication
(10) Pub. No.: US 2004/0195750 A1
(43) Pub. Date: Oct. 7, 2004

(54) Electric clamping apparatus with manual control

(75) Inventor: Luciano Migliori, Milan (IT)

Correspondence Address: YOUNG & THOMPSON, 745 SOUTH 23RD STREET 2ND FLOOR, ARLINGTON, VA, 22202

(73) Assignee: UNIVER S.P.A., MILAN (IT)

(21) Appl. No.: 10/812,926

(22) Filed: Mar. 31, 2004

(30) Foreign Application Priority Data
Apr. 4, 2003 (IT) MI2003A 000666

(51) Int. Cl. B25B 1/06

(52) U.S. Cl. 269/216

(57) ABSTRACT

The apparatus comprises a clamping device having a box-shaped casing and a clamping member for clamping work pieces, operatively connected to an electric actuator to move the clamping member between a first and a second operative position. The clamping apparatus is also provided with electric switching means which can be manually operated by a control member to reverse the polarities of the power voltage supply to the electric actuator, to selectively control the movement of the clamping member in respect to both operative positions; the control member may be in the form of a manually operable lever or control buttons.

### BACKGROUND OF THE INVENTION

This invention refers to an electrically and manually operable apparatus for clamping and/or centring work pieces, used for example in the automotive industry to clamp metal sheets or parts to be welded or assembled along working lines.

Usually an assembling lines it is necessary to make use of a large number of clamping and/or centering apparatuses connected to a central control unit, which must be used from time to time for different working conditions and working programs.

Within the sphere of the aforesaid applications, at present use is prevalently made of clamping apparatuses provided with a pneumatic actuator, which by means of appropriate mechanical solutions can be operated either automatically or manually.

In particular, the manual operation is necessary during the initial setting of the assembling line, or for specific interventions on certain clamping apparatuses, in the event of breakdowns and irregular operation along the working line.

In substitution of the pneumatically-operated clamping apparatuses, has been also suggested to use electrically-operated clamping apparatuses, in that they make it possible to improve and simplify the management of command and control operations within a same assembling plant.

Electrically-operated clamping apparatuses are described for example in EP 0 243 599, EP 0 255 853 and WO 02/34473.

As can be seen from the aforesaid documents, an electrically-operated clamping apparatus comprises a box-shaped casing and a pivotally supported clamping arm operatively connected to an electric actuator provided for example by one or more electric drive motors; the clamping arm is made to rotate between a first angular position, or closed position in which the clamping arm locks a work piece against a shoulder or against another work piece, and a second angular position, or open position, in which the clamping arm releases the aforesaid work piece or pieces.

Similar clamping apparatuses usually comprise position detection means for the clamping arm, such as sensors operatively connected to an electronic control unit to supply the latter with control signals upon reaching the angular open and closed position of the clamping arm.

The operative connection between the electric actuator and the clamping arm, in general is achieved by means of a gear system, for example a gear reduction unit and/or a screw-nut coupling device which, due to the high reduction ratio and internal frictional forces make it difficult, if not practically impossible, to provide a clamping apparatus of this kind with a manually-operable mechanical opening and closing system.

Within the general problem of this kind, there is also the need to seek solutions of standardised manual controls, which can be indifferently applied to any type of electric clamping apparatus, specifically preset for an application of this kind.

Furthermore, the manually operable clamping device presently in use are not suitable for local and/or remote control, as well as do not conform to varying working condition of the clamping apparatus or of the working line.

At present there are no known electric clamping apparatuses provided with manually oparable control devices nor any solutions capable of solving the aforementioned problems.

### OBJECTS OF THE INVENTION

The general object of this invention is to provide an electrically-operable clamping apparatus, which is provided with manual control means, to selectively command the movement of a work clamping or retaining member between different operative positions, for example during the setting up of a working line, normal working or for any other requirement.

For the purposes of this description, the expression “clamping apparatus”, is understood to mean any type of apparatus provided with a movable member, for example a rotating arm, a hook-shaped or stud-shaped element, for clamping, hooking and/or centring metal sheets or work pieces; further on, reference will be made to apparatuses provided with a rotary clamping arm, merely by way of example to illustrate one of the various types of apparatuses to which this invention is addressed.

A further object of this invention is to provide an electrically-operable clamping apparatus, with a manual control device, which allows a certain degree of standardisation and the use of different types of manual controls with a same clamping apparatus, or a same type of manual control with clamping apparatuses of different types.

A still further object of this invention is to provide an electrically-operable clamping apparatus, as previously mentioned, in which the manual control device is functionally integrated into the same apparatus, that is to say either directly onto the apparatus itself, or located in a remote position.

A still further object of this invention, is to provide a clamping apparatus with a manual control device, of the aforementioned kind, which is capable of providing working conditions phisically comparable to those of a mechanical manual control of conventional type, normally used with pneumatically-operated clamping apparatuses, so as to comply with the manual skills and work routines already acquired by an operator.

### BRIEF DESCRIPTION OF THE INVENTION

Further features and some preferential embodiments of a manual control for electrically operated clamping apparatuses according to this invention, are defined in the dependent claims.

According to a first aspect of the invention, a clamping apparatus has been provided for clamping work pieces, the apparatus comprising:

a clamping device having a box-shaped casing;

a work clamping member movably supported by the casing;

an electric actuator, said clamping member being operatively connected to the electric actuator to be moved between first and second operative positions; and

a power supply electric circuit operatively connected to an electronic control unit, for supplying the electric actuator with a power voltage having opposite polarities, during forward and reverse rotation of the same actuator;

characterised by comprising:

a manually operable control device to provide control signals to the electronic control unit;

said manually operable control device comprising electric or electronic switching means operatively connected to the electronic control unit programmed to selectively reverse the power voltage polarities of the electric actuator, depending on the required direction of movement for the clamping member of the clamping device.

The manual control device can comprise any type of switch control member for operating the electric or electronic switch means, and for reversal of the polarities of the power voltage supplied to the actuator; for example, may comprise a lever-operated control member, a pushbutton operated by the pressure of a finger, a touch-sensitive pushbutton operated by a pointed instrument, or any other type of manual control member.

The manual control device can be integrated or secured directly to the box-shaped casing of the clamping device, or positioned far from the device, for a remote control.

Preferably, in order to allow a general use of the manual control, regardless of the type and characteristics of the clamping device, the control device may comprise a support block conformed for housing the electric switch means, said suport block being constructed and arranged to be directly secured to the box-shaped casing of the clamping device, or to a support structure in a remote position.

According to a preferential embodiment, the electric or electronic switching means may comprise a first and a second sensor, which may be selectively operated by a control lever or by a manual control pushbutton.

The switching sensors are housed in a front open cavity of the support block, in a spaced apart relationship; a sensor control member is connected to a manually operable lever or other manual control means, to be selectively moved between a central inoperative position, and a first, respectively a second operative side positions in which the switching sensors are activated; biasing spring means being provided to return and maintain the sensor control member in the central position, upon releasing of the manually operable control means.

The electronic control unit of the electric actuator can comprise a microprocessor programmed to control the working mode of the electric actuator, during the manual operation, so as to cause a fast, a slow or a step-by-step movement of the clamping member during the closure or the opening of the clamping device.

### BRIEF DESCRIPTION OF THE DRAWINGS

These and further features and advantages of an electrically-operated clamping apparatus provided, with a manual control according to this invention, will be more clearly evident from the following description and from the accompanying drawings relating to some preferential embodiments, in which:

FIG. 1 shows a general diagram of an electrically-operated clamping apparatus, with manual control according to this invention;

FIG. 2 shows a perspective view of the clamping apparatus provided with a lever-operated manual control device;

FIG. 3 shows a sectional view of the support block for the manual control device of FIG. 2, in a non-operative condition;

FIG. 4 shows a view similar to that of FIG. 3, in an operative condition;

FIG. 5 shows a sectional view along the line 5-5 of FIG. 3;

FIG. 6 shows a perspective view of a clamping apparatus, with the lever-operated manual control device in a remote position;

FIG. 7 shows an enlarged sectional view of the remote control device of FIG. 6;

FIG. 8 shows a perspective view of a clamping apparatus, with a pushbutton control device;

FIG. 9 shows an enlarged sectional view of the pushbutton control device of FIG. 8, along the line 9-9 of FIG. 10;

FIG. 10 shows a sectional view along the line 10-10 of FIG. 9;

FIG. 11 is a flow diagram showing automatic and manual operating modes of a clamping apparatus provided with a manual control device according to the invention.

### DETAILED DESCRIPTION OF THE INVENTION

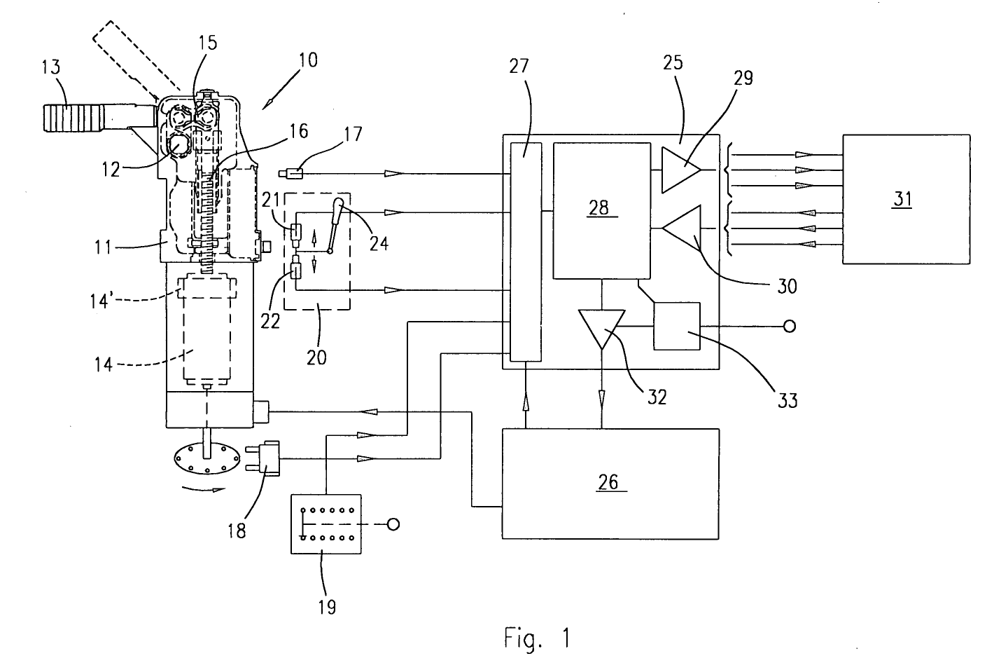

With reference to FIG. 1, a description is given hereunder of an electrically-operated clamping apparatus, provided with a manual control device according to the invention, being understood that what is described hereunder, must be referred to any type of clamping apparatus.

Reference number 10 in FIG. 1 indicates, as a whole, a clamping apparatus particularly suitable for use in the automotive industry; the apparatus comprises, in a per se known way, a clamping device having a box-shaped casing 11 to which a clamping arm 13 is pivoted in 12 for retaining any type of work piece against a shoulder or against another work piece to which it is to be welded or connected.

The clamping arm 13 is pivotally supported to be angularly movable between a first and a second operative position, for example between an open position represented by the phantom lines in FIG. 1, in which the arm 13 releases the work piece or work pieces, and a closed position represented by the continuous lines, in which the arm 13 locks a work piece against a supporting shoulder or surface.

The clamping arm 13 is operatively connected to an electric actuator 14, for example an electric motor, by means of toggle lever link 15, an axially extendable thrust member 16, consisting for example of a screw-nut device, and a gear reduction unit 14′.

The operative connection between the clamping arm 13 and the electric motor 14 can be of any appropriate type and has been schematically indicated in FIG. 1 purely by way of example.

The clamping apparatus also comprises automatically and manually operable electric switching means for reversal of the polarities of the power voltage supplied to the electric motor 14, to cause the latter to rotate in one forward direction and in the reverse or opposite direction with respect to the first one.

The electric switching means can be of any suitable type; for example, as shown, they can comprise a first sensor 17 capable of providing control signals in the closed position of the arm 13, and a second sensor 18 capable of providing control signals in the open position of the arm 13.

The sensors 17 and 18 can be of any type, for example optical, magnetic, inductive or of any other type; in particular, the sensor 18 can consist of a rotatry encoder connected to the shaft of the drive motor 14 so as to generate a set of electrical signals which enable the programming and control of the opening and closing movement of the arm 13.

This can be achieved for example by acting on a manually operable selector 19 whereby it is possible to preset various functions and to change the angle of aperture of the arm 13.

The clamping apparatus 10 also comprises a manual control device 20 which, whenever necessary, can be actuated by an operator to switch the polarities of the power voltage to the motor 14, and consequently cause the opening or closing rotation of the arm 13.

The manual control device 20 can be of any suitable type; for example it can be of the lever-operated, or pushbutton-operated type; in general it comprises electric switching means consisting, in the example under consideration, of a first sensor 21, a second sensor 22, and a manually operable control member 24 for selectively activating either one or the other of the two sensors 21 and 22.

The two switching sensors 21 and 22 provide electrical control signals indicative of the direction of rotation of the motor 14, to a local control unit 25 relative to a specific clamping device, operatively connected to a power voltage supplying circuit 26. The voltage supplying circuit 26 is designed to reverse the voltage polarities of the power supplied to the motor 14, both when operating in the automatic mode, and following the operation of the manual control 20 by an operator.

More precisely, as shown by the diagram in FIG. 1, the sensors 17, 18, 21, 22, or similar switching devices for switching and/or detecting the positions of the clamping arm 13, as well as the selector 19 are connected, by means of an interface 27, to a microprocessor 28 inside local control unit 25.

The microprocessor 28 is in turn connected, by means of an output buffer 29 and an input buffer 30, to a main control unit 31 for automatically controlling the various clamping apparatuses 10 belonging to a same system or assembly line; the microprocessor 28 is also connected to the power supply circuit 26 for the motor 14 by means of a driver 32, while reference 33 in FIG. 1 indicates a feeding circuit for supplying power to the local control circuit 25.

The microprocessor 28 can be programmed for controlling and monitoring the entire operative cycle of the clamping apparatus 10; in particular, when operating with the manual control device 20, the microprocessor 28 is programmed to control the opening and closing movement of the arm 13 at a lower speed, for example equivalent to half the normal operative speed in the automatic mode, or with a jogging or step by step movement according to the circumstances, having in any case the possibility of stopping the arm 13 in any required position, following the release of the manual control device 20.

As mentioned previously, the manual control device 20 can be of any type and can be positioned anywhere; for example it can be placed directly on the casing 11 of the clamping device, or can be located in a remote position, according to need.

In particular, as will be explained further on, the manual control device 20 can be made interchangeable by providing a support block of standardised dimensions and shape, which can be fastened to any type of clamping device appropriately preset for such purpose.

A first possible application and embodiment of a manual control device 20, is shown in the figures from 2 to 5 of the accompanying drawings.

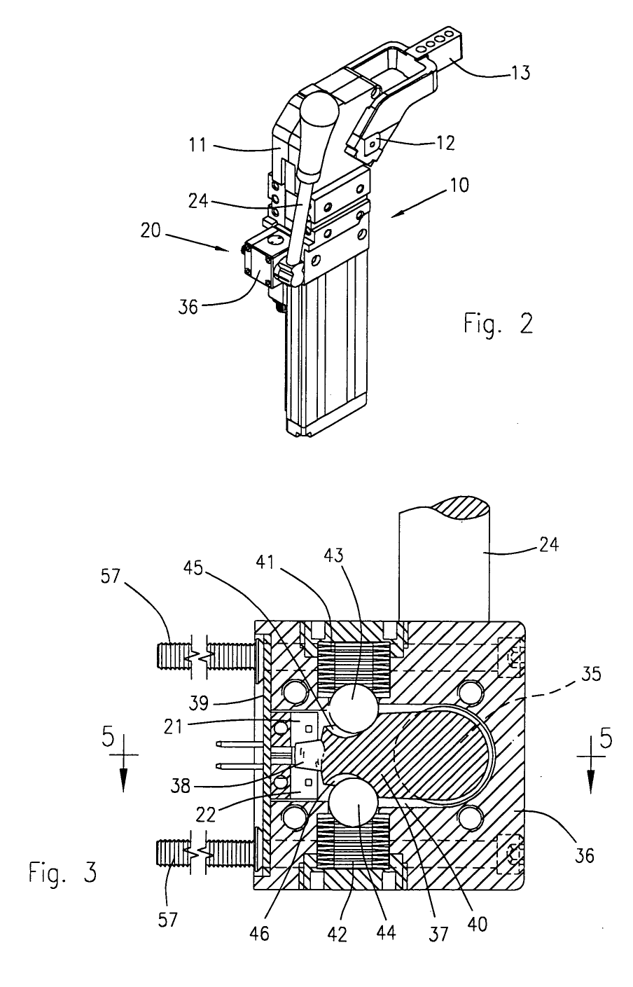

As shown in FIG. 2, where several reference numbers of FIG. 1 have been used to indicate similar or equivalent parts, the clamping apparatus 10 comprises a manual control device 20 operated by a lever 24; the manual control device 20 is secured to one side of the casing 11 opposite the side of the clamping arm 13.

FIGS. 3, 4 and 5 of the drawings show a first embodiment of the lever-operated control device, for the clamping device 10; the lever-operated manual control device has been designed to reproduce, phisically the same functional capacities as a manual control device of mechanical type normally used on pneumatically-operated clamping apparatuses, so as to also support heavy loads applied to the control lever, without affecting the electrical part.

In the example shown in FIGS. 3-5, the control is achieved by means of the lever 24 having three working positions: a first stable non-operative central position, and first and second unstable operative positions, one for closing and the other one for opening the clamping arm 13.

The lever automatically returns to the stable central position upon release of the lever itself. In this connection, as shown in FIGS. 3, 4 and 5, the lever 24 is secured to a pivot pin 35 supported by a block 36 so as to angularly rotate.

The pin 35 of the control lever 24 has a side arm 37, which ends with a flag or flat protrusion 38 for selectively operating the two sensors 21 and 22.

The two sensors 21 and 22 are supported in spaced apart positions by a plate 39, which closes a cavity 40 for housing the sensors 21, 22.

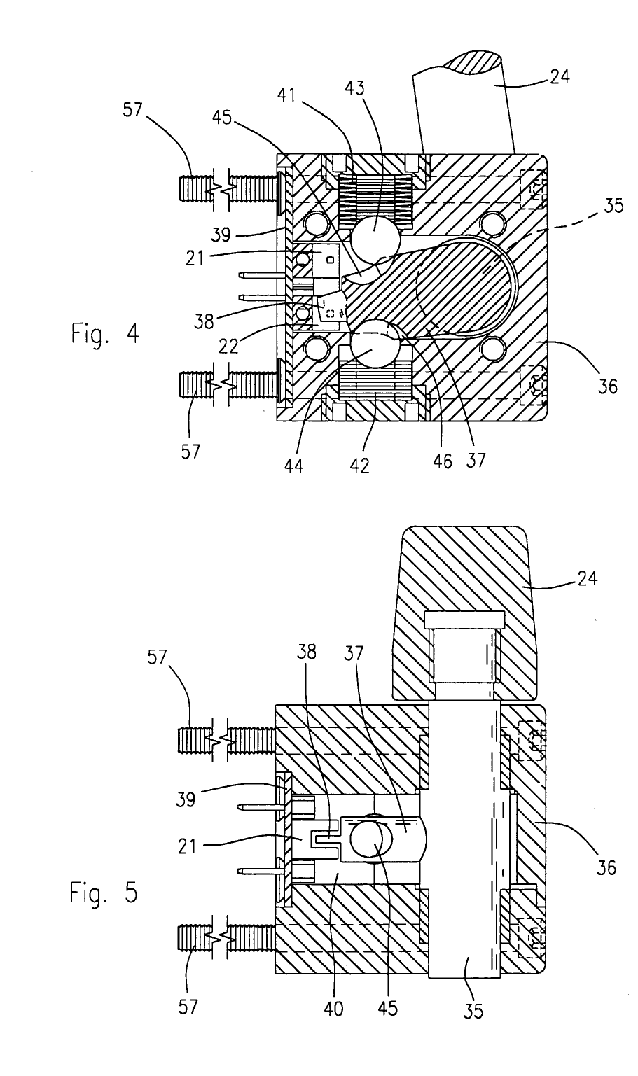

As mentioned previously, the control lever 24 is movable in three positions, in a particular in a central non-operative position, shown in FIG. 3 and in two side operative positions, only one of which is shown in FIG. 4; in the side positions the lever selectively activates the two sensors 21 and 22 for opening and respectively closing the clamping arm of the device.

The arm 37 of the control lever 24 is constantly maintained in its central position, and is automatically returned to this position by the action of appropriate biasing means, suitably shaped and disposed inside the support block.

For example, as shown, said biasing means can consist of a pack of cup shaped springs 41, 42 which act on two opposing sides of the arm 37 of the control lever 24, by the interposition of a rolling member 43, 44 consisting for example of a ball member disposed between each pack of springs 41, 42 and a respective seat 45, 46 in the arm 37 of the control lever 24.

The biasing means also can be made in any way: for example they can consist of any type of flat springs, spiral springs or cup shaped springs housed in appropriate seats in the support block 36.

In the case of FIGS. 3-5, the manual control device 20 is positioned and fastened directly on the box-shaped casing 11 of the clamping device 10.

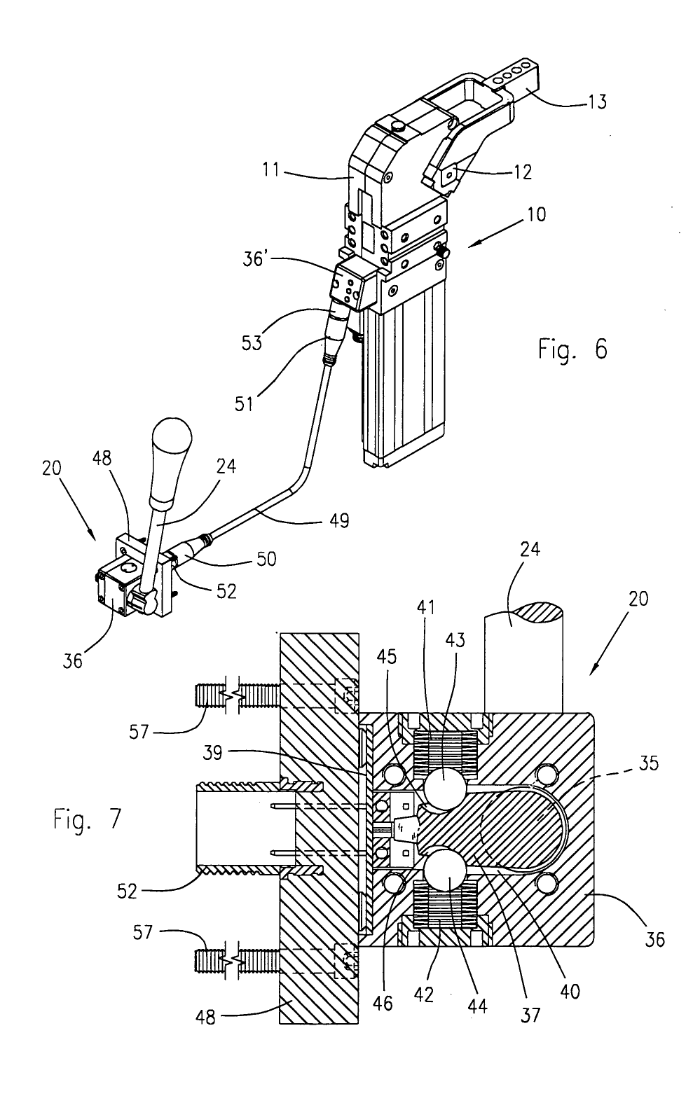

According to another possible solution, shown in FIGS. 6 and 7, the manual control device 20 can be located in a remote position with respect to the clamping device 10.

Also in FIGS. 6 and 7, the same reference numbers as those of the previous figures, have been used to indicate similar or equivalent parts.

Again, the manual control device 20 comprises a standardised support block wholly identical to the block 36 of FIG. 3, having a front open cavity for housing the two sensors 21 and 22, the arm 37 of the control lever 24 and the biasing springs 41 and 42.

In the case of FIGS. 6 and 7, the support block 36 is secured, by means of screws, to a flange 48 by which the manual control device 20 can be removably secured to any support structure or surface, in a position remote from the clamping apparatus 10.

The electrical connection between the sensors 21 and 22 inside the block 36, and the circuit of the local control unit 25 which governs the operative cycle of the clamping device 10, or the electrical circuit which controls the power to the electric motor 14, located inside the device 10, is achieved by means of an electric cable 49 of appropriate length; the cable 49 is provided with electrical connectors 50 and 51 at its ends, which plug into corresponding connectors 52, 53 provided on the flange 48 of the support block 36, as well as on an ancillary block 36′ removably secured to the casing 11 of the clamping device; the block 36′ is also of standardised dimensions likewise to the block 36 of the manual control device 20 shown in FIG. 2.

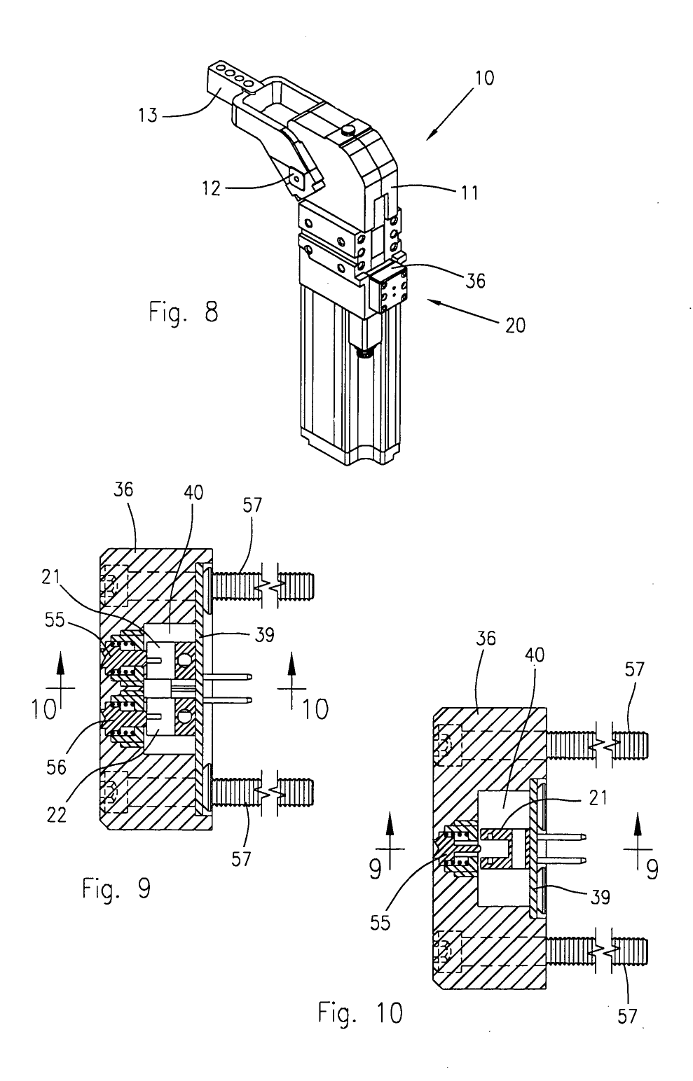

A third alternative solution is shown in FIGS. 8, 9 and 10 of the accompanying drawings, where the same reference numbers have again been used to indicate parts similar or equivalent to the preceding examples.

In this case too, the clamping device 10 is provided with a manual control device 20 fastened to the clamping apparatus itself, which enables the clamping arm 13 to be moved to the open and closed position by pressing appropriate pushbuttons 55, 56 operated by means of a finger, whenever the pushbuttons 55 and 56 are protruding, or by means of a pointed instrument whenever they are integrated into the block itself, or are of the so-called “touch-sensitive” type.

Again, the support block 36 is of standardised dimensions to enable it to be fitted as a part of the clamping device.

Also in the case of FIGS. 8-10, the block 36 is provided with a cavity 40 for housing the sensors 21 and 22 or other equivalent electrical switching devices, likewise to the blocks 36 of the preceding examples.

The example of FIGS. 8-10 differs from the preceding examples in that the two sensors 21 and 22 are now operated by pressing a respective pushbutton 55 and 56 accessible from the outside on the front side of the block 36 opposite the side of the closure plate 39 supporting the two sensors 21 and 22.

As previously explained, a feature which is common to the various solutions consists in the use of a block 36 for supporting the manual control device 20, having standardised dimensions to enable it to be secured directly onto the casing 11 of the clamping device 10, in correspondence with an aperture in the box-shaped casing 11, to which the manual control device 20 is secured by means of appropriate screws 57, or in any other suitable way; through this aperture the sensors 21 and 22, or other electrical means for switching the polarities of the power voltage of the electric actuator 14, can be electrically connected to the electric circuit 25 inside the clamping apparatus.

All this offers the manufacturer and the user, the possibility of using the various types of manual control 20, that can be fitted from time to time on any type of control apparatus necessary for a specific use, by merely securing the manual control directly to the casing 11 of the clamping apparatus, or in a remote position, as mentioned previously; all the above results in a considerable practical advantage both as regards the manufacture and the use of the clamping apparatuses, and the respective manual control devices.

Although the pushbutton-operated control device in FIG. 8 has been shown as part of the clamping apparatus, it is clearly evident that also in this case can be located in a remote position, in a similar way to the lever-operated manual control device of the example of FIG. 6.

From what has been described and shown in the accompanying drawings, it will be understood that an electrically-operated clamping apparatus for clamping work pieces, has been provided with a manual control device operatively connected to a control circuit for controlling and supplying power to the electric actuator, which governs its operation both in the automatic mode and in the manual mode.

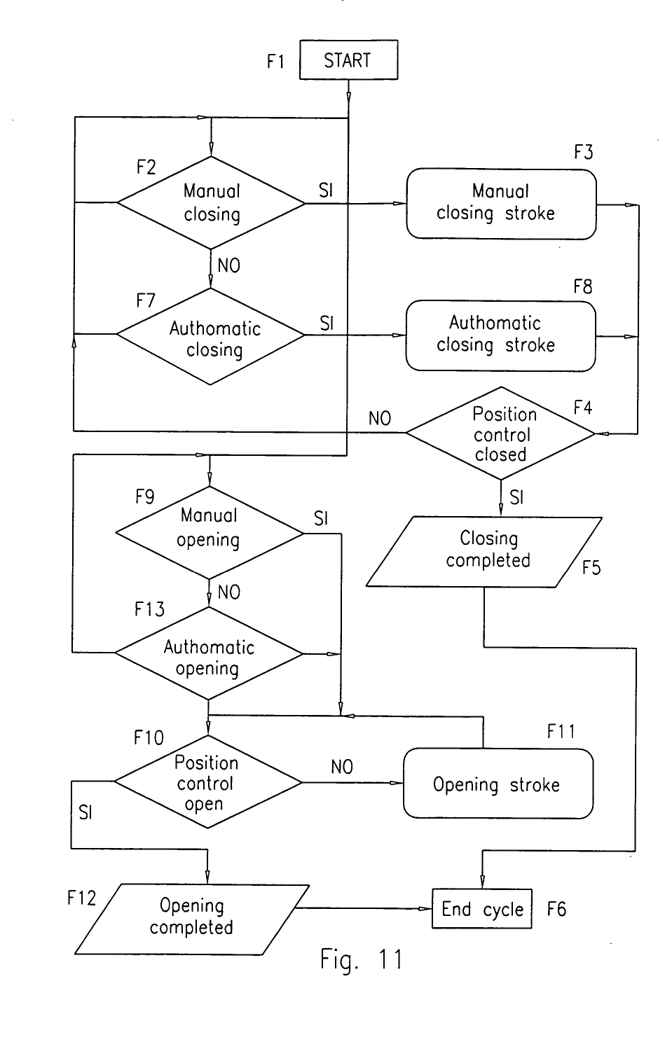

This is explained by way of example by the flow diagram in FIG. 11, which shows the basic operative steps both during the automatic, as well as the manual closing and opening of the clamping device.

Assuming that for any reason, after having set up an installation provided with an apparatus comprising a plurality of clamping devices according to this invention, or during the operation of the installation itself, it is necessary to close one of the clamping devices, this can be done by acting directly on the manual control device 20.

Therefore, by operating for example the lever 24 of the clamping device shown in FIG. 2, making it rotate in the direction for activating the sensor 21, after the “start” step F1, the system will be able to sense whether a command has been given for a manual closing, step F2, or an automatic closing, step F7.

Whenever the system senses that a manual closing command, step F2 (YES), has been given, it will start up the manual closing stroke of the clamping arm 13, step F3, and then proceed to step F4 for controlling the position of the arm 13, by means of the position sensor 17.

Whenever step F4 is negative (NO), the system will return to step F2 and continue to recycle until the position control step F4 is positive (YES).

At this point, a “closing completed” signal, step F5, will be emitted, thereby bringing the cycle to an end step F6.

Whenever the step F2 is negative (NO), the system will automatically proceed to step F7, transmitting a command for the automatic closing of the clamping device, whereupon it will proceed to step F8 during which the automatic closing of the clamping arm 13 will take place.

Again, as long as step F4 continues to give a negative response (NO), the system continues to recycle to step F7 until the sensor 17 provides a “position control completed” signal; it then proceeds to step F5, and to the subsequent end of cycle step F6, as in the previous case.

Assuming that it is now necessary to manually control the opening of the clamping device, by operating the manual control device 20; after the “start” step F1, the system will proceed to step F9 emitting a control signal for the manual opening.

If the response of step F9 is positive (YES), since during step F10 the opening control sensor 18 will give a negative response (NO), by continuing to operate the manual control 20 the opening stroke of the arm 13 will continue until the sensor 18 emits a positive (YES) position control signal, step F10, and the system will proceed to step F12 in which it emits a signal that the opening has been completed, and then on to the end of cycle step F6.

Conversely, whenever the response during step F9 is negative (NO), the system proceeds to step F13 emitting an automatic opening command, and then proceeds to steps F10, F11, F12 and F6 as in the preceding case.

From what has been described and shown, it will be evident that a clamping apparatus has been provided comprising an electrically-operated clamping device with a dual manual and automatic control system for the opening and closing of the apparatus itself.

It is understood, however, that what has been described and shown with reference to the accompanying drawings has been given purely by way of example in order to illustrate preferential embodiments; therefore other modifications may be made both to the clamping device itself, and to the manual control device, without thereby departing from the scope of the invention as specified in the appendent claims.

1. A clamping apparatus for clamping work pieces, of the type comprising:
a clamping device having a box-shaped casing;
a work clamping member movably supported by the casing;
an electric actuator, said clamping member being operatively connected to the electric actuator to move between first and second operative positions; and
a power supply circuit operatively connected to a local control unit and for supplying the electric actuator with a power voltage having oppposite polarities, during forward and reverse rotation of the same actuator;
characterised by comprising:
a manually operable control device to provide control signals to the local control unit;
said manually operable control device comprising electric switching means operatively connected to the local control unit programmed to selectively reverse the power voltage polarities of the electric actuator, depending on the required direction of movement for the clamping member of the clamping device.

2. A clamping apparatus according to claim 1, characterised in that the manual control device is directly secured to the box-shaped casing of the clamping device.

3. A clamping apparatus according to claim 1, characterised in that the manual control device is located in a remote position and is connected by an electric cable to the local control unit inside the box-shaped casing of the clamping device.

4. A clamping apparatus according to claim 1, characterised in that the manual control device comprises a manually-operable control member for the electric switching means.

5. A clamping apparatus according to claim 4, characterised in that said manual control member consists of a control lever.

6. A clamping apparatus according to claim 4, characterised in that said manual control member consists of a pushbutton.

7. A clamping apparatus according to claim 1, characterised by comprising:
a support block for the manually operable control device;
a first and a second sensor means, in an open cavity of said support block; and
manually-operable control means for selectively controlling said first and second sensor;
said support block for the manual control device being conformed with standardised dimensions for connection to any type of the box-shaped casing of a clamping device.

8. A clamping apparatus according to claim 7, characterised in that said control means comprise a manually operable control member movable between a central inoperative position, and first and second operative side positions for switching said first and second sensor means; and elastically biasing means, acting on both sides of the control member to return and maintain the control member in said central inoperative position.

9. A clamping apparatus according to claim 8, characterised in that said elastically biasing means comprise first and second spring means on opposite sides of the control member.

10. A clamping apparatus according to claim 8, characterised in that a rolling member is disposed between each spring means, and a corresponding side of an extention of the manual control member.

11. A clamping apparatus according to claim 10, characterised in that said extention of the manual control member, is provided with seats for said rolling member.

12. A clamping apparatus according to claim 1, further characterised by comprising an electric selector operatively connected to the local control unit said local control unit being progammed to vary at least one of the operative positions of work clamping member depending on the operative position selected by said electric selector.

13. A clamping apparatus according to claim 1, characterised in that the local control unit comprises a programmable microprocessor programmed to vary the rotational speed of the electric actuator during the manual operation.

14. A clamping apparatus according to claim 13, characterised in that said microprocessor is programmed to reduce the said rotational speed and the movement of the clamping member of the clamping device.

15. A clamping according to claim 13, characterised in that said microprocessor is programmed to control a step-by-step said rotational speed and movement of the clamping member of the clamping device.
